(19) United States
(12) Patent Application Publication
(10) Pub. No.: US 2024/0027810 A1
(43) Pub. Date: Jan. 25, 2024

(54) DISPLAY DEVICE

(71) Applicant: Shanghai Tianma Micro-Electronics Co., Ltd., Shanghai (CN)

(72) Inventors: Akira SUZUKI, Kawasaki (JP); Futoshi NAKANISHI, Kawasaki (JP); Hitoshi YOSHIDA, Kawasaki (JP); Noriyuki ITOU, Kawasaki (JP); Akira BANJOUYA, Kawasaki (JP); Shingo ASAKA, Kawasaki (JP); Koetsu ISHIKAWA, Kawasaki (JP)

(73) Assignee: Shanghai Tianma Micro-Electronics Co., Ltd., Shanghai (CN)

(21) Appl. No.: 18/352,642

(22) Filed: Jul. 14, 2023

(30) Foreign Application Priority Data
Jul. 22, 2022 (JP) 2022-116830
Mar. 29, 2023 (JP) 2023-052836

(51) Int. Cl. G02F 1/1333; G06F 3/041; B32B 7/02; B32B 17/10

(52) U.S. Cl. CPC G02F 1/133331; G06F 3/0412; B32B 7/02; B32B 17/10761; B32B 17/10045; G02F 1/13338; G02F 2202/28; G06F 3/0446

(57) ABSTRACT

A display device includes a display panel, and a protector provided on a display surface of the display panel. The protector includes a first glass substrate positioned on a user side, a second glass substrate positioned between the first glass substrate and display surface, and a first adhesive layer that adheres the first glass substrate and the second glass substrate to each other. A thickness of the first glass substrate is 0.5 mm or less, and a pummel value of the first adhesive layer is from 7 to 10.

### CROSS-REFERENCE TO RELATED APPLICATIONS

This application claims the benefit of Japanese Patent Application No. 2022-116830, filed on Jul. 22, 2022, and Japanese Patent Application No. 2023-052836, filed on Mar. 29, 2023, of which the entirety of the disclosures is incorporated by reference herein.

### FIELD OF THE INVENTION

The present disclosure relates generally to a display device.

### BACKGROUND OF THE INVENTION

In order to enhance the safety of riders (crew, passengers, and the like) on vehicles, trains, and the like, it is necessary to reduce injury done to the riders by display devices provided in the vehicles, trains, and the like. For example, the European standards for vehicles (ECE-R21: the Economic Commission for Europe of the United Nations (UN/ECE)-Regulation No. 21) applies to interior components of vehicles, including display devices. ECE-R21 requires that the internal components of vehicles are non-lethal.

Meanwhile, glass laminates that have excellent durability, sound-suppression characteristics, and fracture characteristics are known. For example, Japanese Patent No. 6328619 discloses a glass laminate including a first outside glass plate, a second outside glass plate, and a polymer intermediate layer. The first outside glass plate and the second outside glass plate have thicknesses of less than 2 mm, and at least one of the first outside glass plate or the second outside glass plate is implemented as chemically strengthened glass. The polymer intermediate layer is formed from a specific polymer material such as ionomer, polycarbonate, or the like. Furthermore, the glass laminate of Japanese Patent No. 6328619 has a pummel value of at least 7.

In the glass laminate of Japanese Patent No. 6328619, the glass and polymer material to be used are limited. In particular, expensive chemically strengthened glass is used in the glass laminate of Japanese Patent No. 6328619. Additionally, lethality to a user is not sufficiently considered in the glass laminate of Japanese Patent No. 6328619.

### SUMMARY OF THE INVENTION

A display device of the present disclosure includes:
a display panel; and
a protector provided on a display surface of the display panel, wherein
the protector includes a first glass substrate positioned on a user side, a second glass substrate positioned between the first glass substrate and the display surface, and a first adhesive layer that adheres the first glass substrate and the second glass substrate to each other,
a thickness of the first glass substrate is 0.5 mm or less, and
a pummel value of the first adhesive layer is from 7 to 10.

It is to be understood that both the foregoing general description and the following detailed description are exemplary and explanatory and are not restrictive of this disclosure.

### BRIEF DESCRIPTION OF DRAWINGS

A more complete understanding of this application can be obtained when the following detailed description is considered in conjunction with the following drawings, in which:

FIG. 1 is a plan view illustrating a display device according to Embodiment 1;

FIG. 2 is a cross-sectional view of the display device illustrated in FIG. 1, taken along line A-A;

FIG. 3 is a cross-sectional view illustrating a liquid crystal display panel according to Embodiment 1;

FIG. 4 is a cross-sectional view illustrating a protector according to Embodiment 1;

FIG. 5 is a schematic drawing illustrating fracturing of the protector according to Embodiment 1;

FIG. 6 is a cross-sectional view illustrating a protector according to Embodiment 2;

FIG. 7 is a plan view illustrating a second glass substrate according to Embodiment 3;

FIG. 8 is a cross-sectional view illustrating a protector according to a modified example;

FIG. 9 is a schematic drawing illustrating a maximum diameter of scattering material according to Example 1 and Comparative Example 1;

FIG. 10 is a drawing illustrating the relationship between a thickness of a first glass substrate and an average maximum diameter of the scattering material according to Example 1 and Comparative Example 1;

FIG. 11 is a drawing illustrating the relationship between a pummel value of a first adhesive layer and the average maximum diameter of the scattering material according to Example 2 and Comparative Example 2;

FIG. 12 is a drawing illustrating the relationship between a pummel value of a second adhesive layer and a step according to Example 3; and

FIG. 13 is a drawing illustrating fixing of a display device according to Example 4.

### DETAILED DESCRIPTION OF THE INVENTION

Hereinafter, a display device according to various embodiments is described while referencing the drawings.

### Embodiment 1

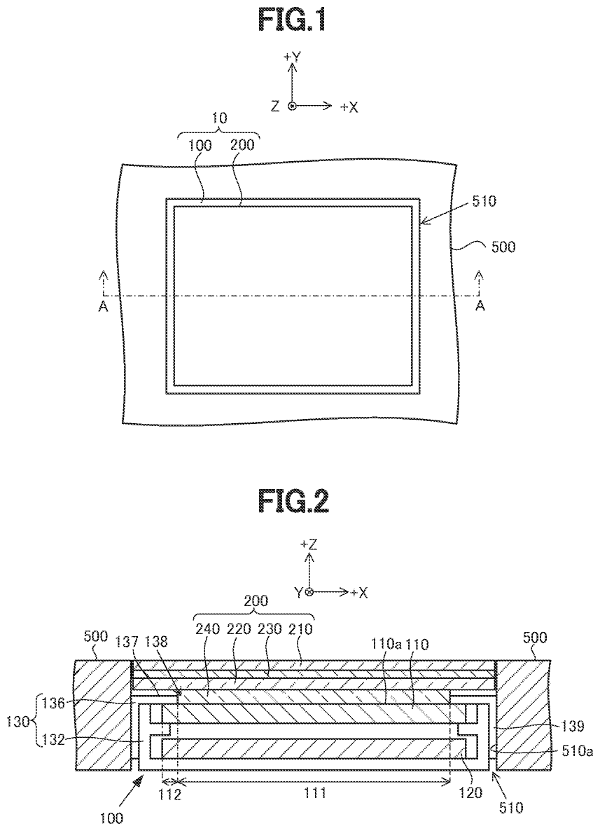

A display device 10 according to the present embodiment is described while referencing FIGS. 1 to 5. The display device 10 is mounted in a vehicle, an airplane, on a household appliance, a piece of furniture, or the like. In the present embodiment and the following embodiments, examples in which the display device 10 is mounted in a vehicle are described. The rider of the vehicle corresponds to a user (an observer).

As illustrated in FIGS. 1 and 2, the display device 10 is disposed on an open section 510 of an instrument panel 500 of the vehicle. In one example, the instrument panel 500 is formed from a resin. Note that, in the present description, to facilitate comprehension, in the display device 10 of FIG. 1, the longitudinal direction (the right direction on paper) is referred to as the “+X direction”, the transverse direction (the up direction on paper) is referred to as the “+Y direction”, and the direction perpendicular to the +X direction and the +Y direction (the front direction on paper, the rider side) is referred to as the “+Z direction.”

The display device 10 includes a display 100 and a protector 200. The display 100 displays characters, images, and the like. The protector 200 protects a hereinafter described display panel 110 of the display 100.

As illustrated in FIG. 2, the display 100 of the display device 10 includes a liquid crystal display panel 110, a back light 120, and a housing 130. Note that, to facilitate comprehension, the hatching of the housing 130 is omitted from FIG. 2.

In one example, the liquid crystal display panel 110 of the display 100 is implemented as a known transmissive horizontal electric field type liquid crystal display panel. The liquid crystal display panel 110 is active matrix driven by thin film transistors (TFT). The liquid crystal display panel 110 displays the characters, images, and the like by modulating light from the back light 120. The liquid crystal display panel 110 includes a display region 111 and a periphery 112. The display region 111 is a region in which pixels are arranged in a matrix and is capable of displaying the characters, images, and the like. The periphery 112 is a region in which wirings, driving circuits, and the like are disposed.

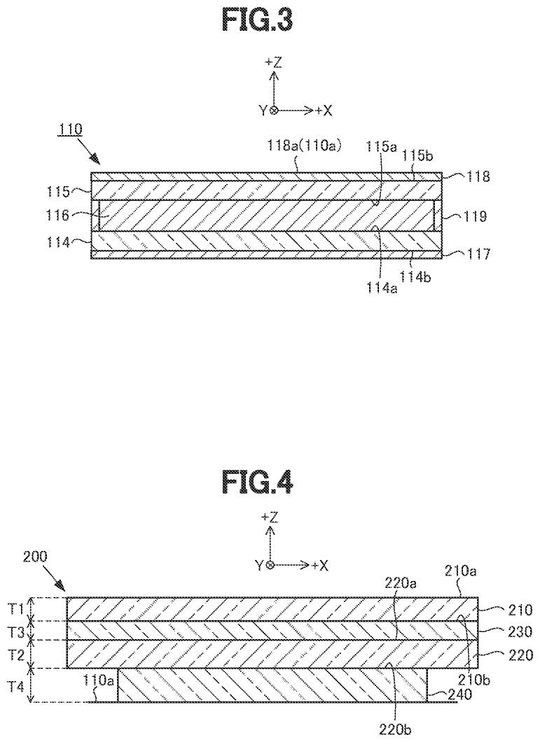

As illustrated in FIG. 3, the liquid crystal display panel 110 includes a TFT substrate 114, a counter substrate 115, a liquid crystal 116, a first polarizing plate 117, and a second polarizing plate 118. The TFT substrate 114 and the counter substrate 115 sandwich the liquid crystal 116. The first polarizing plate 117 is provided on the TFT substrate 114. The second polarizing plate 118 is provided on the counter substrate 115.

In one example, the TFT substrate 114 is implemented as a glass substrate. The TFT substrate 114 is positioned on the −Z side. TFTs for selecting the pixels, common electrodes, pixel electrodes, a drive circuit, an alignment film for aligning the liquid crystal 116, and the like (all not illustrated in the drawings) are provided on a main surface 114a on the liquid crystal 116 side of the TFT substrate 114. The first polarizing plate 117 is provided on a main surface 114b on the side opposite the main surface 114a of the TFT substrate 114.

The counter substrate 115 is positioned on the +Z side, and opposes the TFT substrate 114. The counter substrate 115 is adhered to the TFT substrate 114 by a seal material 119. In one example, the counter substrate 115 is implemented as a glass substrate. A color filter, a black matrix, an alignment film for aligning the liquid crystal 116, and the like (all not illustrated in the drawings) are provided on a main surface 115a on the liquid crystal 116 side of the counter substrate 115. The second polarizing plate 118 is provided on a main surface 115b on the side opposite the main surface 115a of the counter substrate 115.

The liquid crystal 116 is sandwiched by the TFT substrate 114 and the counter substrate 115. In one example, the liquid crystal 116 is implemented as a positive nematic liquid crystal. The liquid crystal 116 is initially aligned, by the alignment film, in a direction parallel to the main surface 114a of the TFT substrate 114. Additionally, the liquid crystal 116 rotates in a plane parallel to the main surface 114a of the TFT substrate 114 due to voltage being applied.

The first polarizing plate 117 is provided on the main surface 114b of the TFT substrate 114. The second polarizing plate 118 is provided on the main surface 115b of the counter substrate 115. One transmittance axis of the transmittance axis of the first polarizing plate 117 and the transmittance axis of the second polarizing plate 118 is arranged parallel to the initial alignment direction of the liquid crystal 116. The transmittance axis of the first polarizing plate 117 and the transmittance axis of the second polarizing plate 118 are orthogonal to each other. In the present embodiment, a main surface 118a on the +Z side of the second polarizing plate 118 corresponds to a display surface 110a of the liquid crystal display panel 110.

As illustrated in FIG. 2, the back light 120 of the display 100 is disposed on a back surface side (the −Z side) of the liquid crystal display panel 110. The back light 120 is the light source of the liquid crystal display panel 110, and emits white light on the liquid crystal display panel 110. The back light 120 includes a white light emitting diode (LED), a reflective sheet, a diffusion sheet, a lighting circuit, and the like (all not illustrated in the drawings).

The housing 130 of the display 100 accommodates the liquid crystal display panel 110 and the back light 120. The housing 130 includes a chassis 132 and a bezel 136. Note that a configuration is possible in which the housing 130 does not include the bezel 136.

The chassis 132 has a box-like shape, and is formed from a resin or a metal. The chassis 132 accommodates, on an inner side thereof, the liquid crystal display panel 110 and the back light 120.

The bezel 136 has a box-like shape. An opening 138 is provided on a bottom 137 of the bezel 136. In one example, the bezel 136 is formed from a metal. The bezel 136 covers the chassis 132 with the bottom 137 facing the +Z side, and protects the periphery 112 of the liquid crystal display panel 110. The display region 111 of the liquid crystal display panel 110 is exposed through the opening 138. In the present embodiment, a side plate 139 of the bezel 136 is adhered to an inner wall 510a of the open section 510 of the instrument panel 500 by a non-illustrated adhesive. Due to this, the display device 10 is fixed to the open section 510 of the instrument panel 500.

As illustrated in FIG. 2, the protector 200 of the display device 10 is provided on the display surface (surface of the +Z side) 110a of the liquid crystal display panel 110. The protector 200 covers the liquid crystal display panel 110. The protector 200 protects the liquid crystal display panel 110. The protector 200 includes a first glass substrate 210, a second glass substrate 220, a first adhesive layer 230, and a second adhesive layer 240.

The first glass substrate 210 of the protector 200 has a rectangular shape, and is positioned on the rider side (the +Z side). As illustrated in FIG. 4, the first glass substrate 210 includes a first main surface 210a on the +Z side and a second main surface 210b on the −Z side.

The first glass substrate 210 is formed from alkali-free glass, borosilicate glass, soda glass, or the like. A thickness (length in the Z direction) T1 of the first glass substrate 210 is 0.5 mm or less. In the present embodiment, the thickness T1 of the first glass substrate 210 positioned on the rider side (the +Z side) is thin (0.5 mm or less) and, as such, the size of scattering material (for example pieces of glass) produced due to fracturing of the first glass substrate 210 is small. As a result, the lethality of the display device 10 decreases.

The second glass substrate 220 of the protector 200 has a rectangular shape. The second glass substrate 220 is positioned between the first glass substrate 210 and the display surface 110a of the liquid crystal display panel 110. The second glass substrate 220 includes a first main surface 220a on the +Z side and a second main surface 220b on the −Z side. The second glass substrate 220 is formed from alkali-free glass, borosilicate glass, soda glass, or the like. In one example, a thickness T2 of the second glass substrate 220 is from 0.3 mm to 2.0 mm.

The first adhesive layer 230 of the protector 200 adheres the first glass substrate 210 and the second glass substrate 220 to each other. Specifically, the first adhesive layer 230 adheres the second main surface 210b of the first glass substrate 210 and the first main surface 220a of the second glass substrate 220 to each other. The first adhesive layer 230 is formed from a polyvinyl acetal resin (for example, polyvinyl butyral), an acrylic resin, a urethane resin, or the like. In one example, a thickness T3 of the first adhesive layer 230 is from 100 μm to 500 μm. In the present embodiment, the pummel value of the first adhesive layer 230 to the first glass substrate 210 and the second glass substrate 220 is from 7 to 10.

Here, the pummel value and a pummel test are described. The pummel value is an index that expresses the adhesion between glass plates and an intermediate layer that form laminated glass, and expresses the adhesive force of the intermediate layer to the glass plates. As the pummel value increases, the adhesive force of the intermediate layer to the glass plates increases. In the present specification, the pummel value of the first adhesive layer 230 to the first glass substrate 210 and the second glass substrate 220 refers to the pummel value of a laminate in which the first glass substrate 210 and the second glass substrate 220 are adhered to each other by the first adhesive layer 230. The pummel value of the first adhesive layer 230 to the first glass substrate 210 and the second glass substrate 220 is proportional to the shear strength of the first adhesive layer 230. Note that, in the present specification, the pummel value of the first adhesive layer 230 to the first glass substrate 210 and the second glass substrate 220 is also referred to as the pummel value of the first adhesive layer 230.

The pummel test is a measurement method for measuring the pummel value. In the pummel test of the present embodiment, firstly, the laminate in which the first glass substrate 210 and the second glass substrate 220 are adhered to each other by the first adhesive layer 230 is allowed to rest at −18° C. for 16 hours. Next, the laminate is placed on a steel plate inclined 45° to the vertical direction and, then, the laminate is struck with a hammer weighing 450 g. Then, the struck laminate is observed, and a degree of exposure of the first adhesive layer 230 is compared with a predetermined limit sample to obtain the pummel value of the first adhesive layer 230. In the present embodiment, the relationship between the pummel value and the degree of exposure of the first adhesive layer 230 is as illustrated in Table 1, and is in compliance with the standards described in U.S. Pat. No. 3,434,915.

TABLE 1

| PUMMEL VALUE | DEGREE OF EXPOSURE (%) |
|---|---|
| 0 | 100 |
| 1 | 95 |
| 2 | 90 |
| 3 | 85 |
| 4 | 60 |
| 5 | 40 |
| 6 | 20 |
| 7 | 10 |
| 8 | 5 |
| 9 | 2 |
| 10 | 0 |

In the present embodiment, the pummel value of the first adhesive layer 230 that adheres the first glass substrate 210 and the second glass substrate 220 to each other is great (from 7 to 10) and, as such, the display device 10 can reduce the amount of scattering material from the first glass substrate 210 caused by the first glass substrate 210 being impacted and the protector 200 fracturing. Furthermore, the display device 10 can suppress pieces of the first glass substrate 210 from peeling from the first adhesive layer 230 prior to the first glass substrate 210 breaking into small pieces. That is, the first glass substrate 210 is broken into small pieces when pieces of the first glass substrate 210 peel from the first adhesive layer 230, and, as such, the display device 10 can reduce the size of the scattering material from the first glass substrate 210. As a result, the lethality of the display device 10 decreases.

The second adhesive layer 240 of the protector 200 adheres the second glass substrate 220 and the liquid crystal display panel 110 to each other. Specifically, the second adhesive layer 240 adheres the second main surface 220b of the second glass substrate 220 and the display surface 110a of the liquid crystal display panel 110 to each other. The second adhesive layer 240 is formed from a polyvinyl acetal resin, an acrylic resin, a urethane resin, or the like. In one example, a thickness T4 of the second adhesive layer 240 is from 100 μm to 500 μm. In the present embodiment, the pummel value of the second adhesive layer 240 to the second glass substrate 220 and the liquid crystal display panel 110 is less than or equal to the pummel value of the first adhesive layer 230 to the first glass substrate 210 and the second glass substrate 220. Note that the pummel value of the second adhesive layer 240 to the second glass substrate 220 and the liquid crystal display panel 110 (hereinafter also referred to as the pummel value of the second adhesive layer 240) refers to the pummel value of a laminate in which the second glass substrate 220 and the liquid crystal display panel 110 are adhered to each other by the second adhesive layer 240. The measuring (pummel test) of the pummel value of the second adhesive layer 240 is the same as the measuring of the pummel value of the first adhesive layer 230. The pummel value of the second adhesive layer 240 is proportional to the shear strength of the second adhesive layer 240.

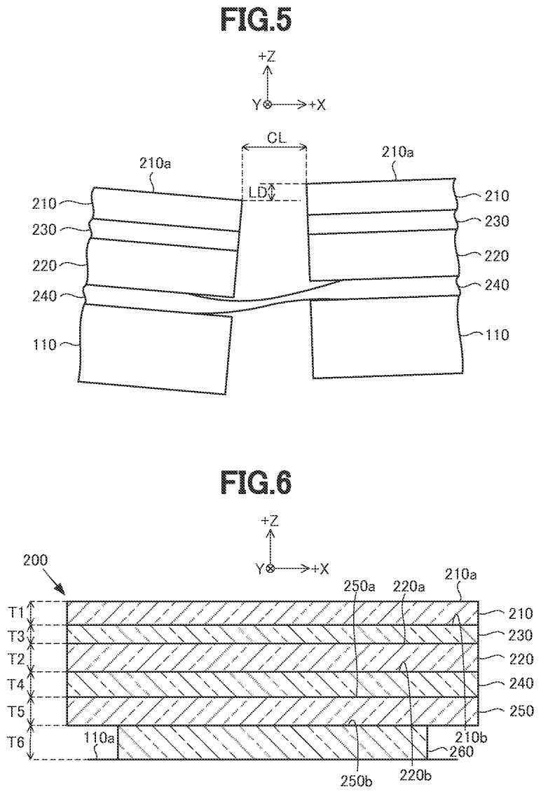

In the present embodiment, the pummel value of the second adhesive layer 240 that adheres the second glass substrate 220, positioned more to the liquid crystal display panel 110 than the first glass substrate 210, and the liquid crystal display panel 110 to each other is less than or equal to the pummel value of the first adhesive layer 230 that adheres the first glass substrate 210 and the second glass substrate 220 to each other. Accordingly, when the first glass substrate 210 is impacted and the protector 200 fractures, as illustrated in FIG. 5, the second adhesive layer 240 peels from the second glass substrate 220 and the liquid crystal display panel 110 and then stretches. As a result, the display device 10 can reduce a step LD of the protector 200 and a width CL of the crack caused by the first glass substrate 210 being impacted and the protector 200 fracturing. Here, as illustrated in FIG. 5, the step LD of the protector 200 is a difference (length in the Z direction) of heights of the first main surface 210a in the broken first glass substrate 210. Additionally, the width CL of the crack is a width between the first main surfaces 210a of the broken first glass substrate 210 when planarly viewing the protector 200 from the rider side. Note that, even when the second adhesive layer 240 breaks, the second adhesive layer 240 stretches until breaking and, as such, the display device 10 can reduce the step LD of the protector 200 and the width CL of the crack of the protector 200.

As described above, the thickness T1 of the first glass substrate 210 positioned on the rider side is 0.5 mm or less and, as such, the size of the scattering material that occurs due the display device 10 fracturing can be reduced. The pummel value of the first adhesive layer 230 to the first glass substrate 210 and the second glass substrate 220 is from 7 to 10 and, as such, the display device 10 can reduce the amount of the scattering material from the first glass substrate 210 and the size of the scattering material from the first glass substrate 210. As a result, the display device 10 can reduce the lethality to the rider.

Furthermore, the pummel value of the second adhesive layer 240 is less than or equal to the pummel value of the first adhesive layer 230 and, as such, the display device 10 can reduce the step LD of the protector 200 and the width CL of the crack of the protector 200 caused by fracturing of the protector 200. As a result, the display device 10 can further reduce the lethality to the rider.

### Embodiment 2

In Embodiment 1, the protector 200 includes the first glass substrate 210 to the second adhesive layer 240. A configuration is possible in which the protector 200 includes the first glass substrate 210 to the second adhesive layer 240, a third glass substrate 250, and a third adhesive layer 260. The configuration of the display 100 of the present embodiment is the same as that of the display 100 of Embodiment 1 and, as such, the protector 200 of the present embodiment is described.

As illustrated in FIG. 6, the protector 200 of the present embodiment includes a first glass substrate 210, a second glass substrate 220, a first adhesive layer 230, a second adhesive layer 240, a third glass substrate 250, and a third adhesive layer 260. With the exception of the second adhesive layer 240 adhering the second glass substrate 220 and the third glass substrate 250, the first glass substrate 210 to the second adhesive layer 240 of the present embodiment are the same as the first glass substrate 210 to the second adhesive layer 240 of Embodiment 1.

The third glass substrate 250 has a rectangular shape. The third glass substrate 250 is positioned between the second glass substrate 220 and the display surface 110a of the liquid crystal display panel 110. The third glass substrate 250 includes a first main surface 250a on the +Z side and a second main surface 250b on the −Z side. The third glass substrate 250 is formed from alkali-free glass, borosilicate glass, soda glass, or the like. In one example, a thickness T5 of the third glass substrate 250 is from 0.3 mm to 1.0 mm.

The third glass substrate 250 is adhered to the second glass substrate 220 by the second adhesive layer 240. Specifically, the first main surface 250a of the third glass substrate 250 and the second main surface 220b of the second glass substrate 220 are adhered to each other by the second adhesive layer 240. As with the pummel value of the second adhesive layer 240 to the second glass substrate 220 and the liquid crystal display panel 110 of Embodiment 1, the pummel value of the second adhesive layer 240 to the third glass substrate 250 and the second glass substrate 220 is less than or equal to the pummel value of the first adhesive layer 230 to the first glass substrate 210 and the second glass substrate 220. Accordingly, as with the display device 10 of Embodiment 1, the display device 10 of the present embodiment can reduce the step LD of the protector 200 and the width CL of the crack of the protector 200 caused by fracturing of the protector 200.

The third adhesive layer 260 adheres the third glass substrate 250 and the liquid crystal display panel 110 to each other. Specifically, the third adhesive layer 260 adheres the second main surface 250b of the third glass substrate 250 and the display surface 110a of the liquid crystal display panel 110 to each other. In one example, the third adhesive layer 260 is formed from a transparent adhesive (for example, optical clear adhesive (OCA), optical clear resin (OCR)), a polyvinyl acetal resin, an acrylic resin, or the like. In one example, a thickness T6 of the third adhesive layer 260 is from 0.5 mm to 1 mm.

In the present embodiment, the adhesive forming the third adhesive layer 260 can be selected in accordance with the state, material, and the like of the display surface 110a of the liquid crystal display panel 110. As a result, with the display device 10 of the present embodiment, the protector 200 and the liquid crystal display panel 110 can be adhered to each other more firmly. Furthermore, inconsistencies in the display of the display device 10 can be suppressed.

As described above, with the display device 10 of the present embodiment, the protector 200 and the liquid crystal display panel 110 can be adhered to each other more firmly. Additionally, as with the display device 10 of Embodiment 1, the display device 10 of the present embodiment can reduce the size of the scattering material from the first glass substrate 210. The display device 10 of the present embodiment can reduce the amount of the scattering material from the first glass substrate 210. Furthermore, the display device 10 of the present embodiment can reduce the step LD of the protector 200 and the width CL of the crack of the protector 200 caused by fracturing of the protector 200. As a result, the display device 10 of the present embodiment can reduce the lethality to the rider.

### Embodiment 3

In Embodiment 1 and Embodiment 2, the protector 200 protects the liquid crystal display panel 110. A configuration is possible in which the protector 200 protects the liquid crystal display panel 110 and, also, functions as a touch panel. In the present embodiment, the second glass substrate 220 of the protector 200 functions as a touch panel. With the exception of the second glass substrate 220 of the protector 200, the configuration of the display device 10 of the present embodiment is the same as that of the display device 10 of Embodiment 1. As such, here, the second glass substrate 220 of the protector 200 of the present embodiment is described.

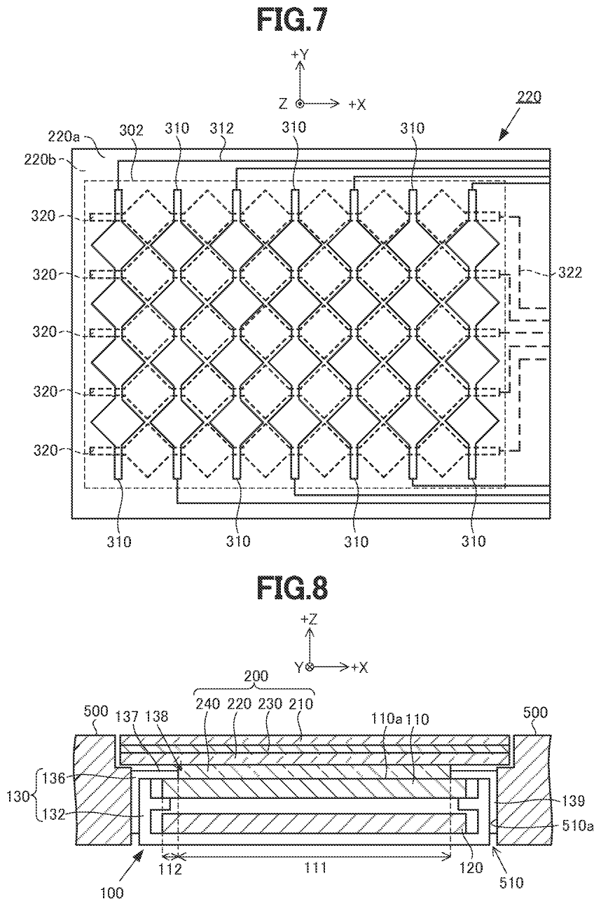

The second glass substrate 220 of the present embodiment functions as a projection-type capacitive touch panel. As illustrated in FIG. 7, the second glass substrate 220 of the present embodiment includes a plurality of drive electrodes 310 and a plurality of detection electrodes 320 in a region 302 corresponding to the display region 111 of the liquid crystal display panel 110.

The drive electrodes 310 are provided on the first main surface 220a of the second glass substrate 220. The drive electrodes 310 extend in the Y direction. The drive electrodes 310 have a pattern in which corners of a plurality of rectangles are connected in a row (a so-called “diamond pattern”). Each of the drive electrodes 310 is connected to a non-illustrated controller via a wiring 312.

The detection electrodes 320 are provided on the second main surface 220b of the second glass substrate 220. The detection electrodes 320 extend in the X direction. The detection electrodes 320 have a pattern in which corners of a plurality of rectangles are connected in a row. Each of the detection electrodes 320 is connected to the controller via a wiring 322.

In one example, the drive electrodes 310 and the detection electrodes 320 are formed from indium tin oxide (ITO). When viewing the second glass substrate 220 from above, the drive electrodes 310 and the detection electrodes 320 cross at connections where the corners of the rectangles connect. When voltage is applied to the drive electrodes 310, capacitance is formed between the drive electrodes 310 and the detection electrodes 320, and an indicator (finger, pen, or the like) of the rider. The controller measures the formed capacitance, thereby enabling detection of the position contacted by the indicator of the rider (self-capacitance detection). Note that the detection method is not limited to self-capacitance detection, and mutual capacitance detection may be used. Additionally, the controller is configured from a central processing unit (CPU), a drive circuit, a detection circuit, and the like.

As described above, the protector 200 (the second glass substrate 220) of the present embodiment functions as a touch panel. Additionally, as with the display device 10 of Embodiment 1, with the display device 10 of the present embodiment, the size of the scattering material from the first glass substrate 210 can be reduced. With the display device 10 of the present embodiment, the amount of the scattering material from the first glass substrate 210 can be reduced. Furthermore, with the display device 10 of the present embodiment, the step LD of the protector 200 and the width CL of the cracks of the protector 200 caused by fracturing of the protector 200 can be reduced. As a result, with the display device 10 of the present embodiment, the lethality to the rider can be reduced.

### Modified Examples

Embodiments have been described, but various modifications can be made to the present disclosure without departing from the spirit and scope of the present disclosure.

For example, a configuration is possible in which the first glass substrate 210 is formed from tempered glass (for example, chemically strengthened aluminosilicate glass). As a result, the scattering material becomes even smaller, and the display device 10 of the present embodiment can further reduce the lethality to the rider.

A configuration is possible in which the first main surface 210a of the first glass substrate 210 is subjected to various types of treatments. For example, the first main surface 210a of the first glass substrate 210 may be subjected to a low reflection treatment.

In the embodiments, the display 100 includes the liquid crystal display panel 110 and the back light 120. However, a configuration is possible in which the display 100 includes a different display panel. For example, a configuration is possible in which the display 100 includes an organic electro-luminescence (EL) display panel instead of the liquid crystal display panel 110 and the back light 120.

In Embodiment 2, it is preferable that the thickness T2 of the second glass substrate 220 is greater than the thickness T1 of the first glass substrate 210 and the thickness T5 of the third glass substrate 250.

In Embodiment 3, the drive electrodes 310 are provided on the first main surface 220a of the second glass substrate 220, and the detection electrodes 320 are provided on the second main surface 220b of the second glass substrate 220. However, a configuration is possible in which the drive electrodes 310 and the detection electrodes 320 are provided on one of the main surfaces of the second glass substrate 220. For example, a configuration is possible in which the drive electrodes 310 and the wirings 312 are provided on the first main surface 220a of the second glass substrate 220, and the detection electrodes 320 and the wirings 322 are provided on an insulating layer formed on the drive electrodes 310 and the first main surface 220a.

In Embodiment 3, the second glass substrate 220 of the protector 200 functions as a touch panel. However, a configuration is possible in which the first glass substrate 210 of Embodiment 1 or Embodiment 3, or the third glass substrate 250 of Embodiment 2 functions as a touch panel. For example, a configuration is possible in which the drive electrodes 310 and the wirings 312 are provided on the first main surface 250a of the third glass substrate 250, and the detection electrodes 320 and the wirings 322 are provided on the second main surface 250b of the third glass substrate 250.

A configuration is possible in which the drive electrodes 310 and the wirings 312 are provided on the second main surface 210b of the first glass substrate 210, and the detection electrodes 320 and the wirings 322 are provided on the first main surface 220a of the second glass substrate 220. A configuration is possible in which the drive electrodes 310 and the wirings 312 are provided on the second main surface 220b of the second glass substrate 220, and the detection electrodes 320 and the wirings 322 are provided on the first main surface 250a of the third glass substrate 250.

In Embodiment 3, the protector 200 functions as a capacitive touch panel. However, a configuration is possible in which the protector 200 functions as a different type of touch panel. For example, a configuration is possible in which the protector 200 functions as an ultrasonic touch panel. In such a case, a transmitter and a receiver (for example, piezoelectric transducers) are provided at the corners of the first glass substrate 210. The transmitter propagates a surface acoustic wave on the surface of the first glass substrate 210, and the receiver detects the contact position of the indicator on the basis of the attenuation of the surface acoustic wave.

A configuration is possible in which the outer shape of the protector 200 is larger than the outer shape of the display 100. For example, as illustrated in FIG. 8, a configuration is possible in which the outer shapes of the first glass substrate 210, the second glass substrate 220, and the first adhesive layer 230 of the protector 200 are larger than the outer shape of the display 100.

Preferred embodiments of the present disclosure have been described, but the present disclosure should not be construed as being limited to these specific embodiments. The scope of the invention is defined only by the included claims, along with the full range of equivalents to which such claims are entitled.

### EXAMPLES

Hereinafter, the present disclosure is described in further detail using examples, but the present disclosure is not limited to these examples.

### Example 1

The display device 10 of Embodiment 2 was fabricated. The first glass substrate 210 was formed from alkali-free glass. The thicknesses T1 of the first glass substrate 210 was 0.15 mm, 0.33 mm, or 0.50 mm. The second glass substrate 220 was formed from soda glass. The thickness T2 of the second glass substrate 220 was 1.1 mm. The third glass substrate 250 was formed from alkali-free glass. The thickness T5 of the third glass substrate 250 was 0.50 mm.

The first adhesive layer 230 was formed from polyvinyl butyral. The thickness T3 of the first adhesive layer 230 was 380 The pummel value of the first adhesive layer 230 was 9. The second adhesive layer 240 was formed from polyvinyl butyral. The thickness T4 of the second adhesive layer 240 was 380 μm. The pummel value of the second adhesive layer 240 was 9. The third adhesive layer 260 was formed from OCR. The thickness T6 of the third adhesive layer 260 was 1035 μm.

Furthermore, a display device of Comparative Example 1 was fabricated. The thickness T1 of the first glass substrate 210 in the display device of Comparative Example 1 was 1.1 mm or 3.0 mm. With the exception of the thickness T1 of the first glass substrate 210, the configuration of the display device of Comparative Example 1 was the same as the display device 10 of the present example.

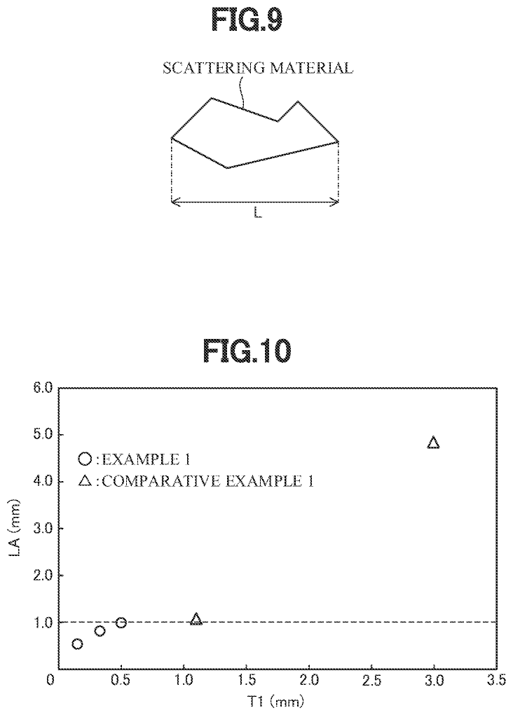

An impact tester was used to cause a spherical impactor having a diameter of 165 mm and a weight of 6.8 kg to impact, at 24.1 km/h, the center of the first main surface 210a of the first glass substrate 210 of the display device 10 of the present example or the display device of the comparative example. Then, a microscope was used to obtain the average maximum diameter LA of the scattering material produced by the impact of the impactor. As illustrated in FIG. 9, the maximum diameter L of the scattering material is the longest width of the scattering material. The average maximum diameter LA of the scattering material is an average value of the maximum diameters L of five to ten pieces of the scattering material. Furthermore, a vernier caliper was used to measure the step LD and the width CL of the crack of the fractured display device 10 of the present example and the fractured display device of the comparative example.

FIG. 10 illustrates the relationship between the thickness T1 of the first glass substrate 210 and the average maximum diameter LA of the scattering material. As illustrated in FIG. 10, the average maximum diameter LA of the scattering material produced from the display device 10 of the present example was 1.0 mm or less and, thus, the size of the scattering material produced from the display device 10 of the present example was small. Meanwhile, the average maximum diameter LA of the scattering material produced from the display device of the comparative example was greater than 1.0 mm. Accordingly, the display device 10 of the present example can reduce the size of the scattering material, and can reduce the lethality to the rider.

The step LD of the display device 10 of the present example that fractured due to the impact of the impactor was 1.0 mm or less. The width CL of the crack of the display device 10 of the present example that fractured due to the impact of the impactor was 2.0 mm or less. Meanwhile, the step LD of the display device of the comparative example that fractured due to the impact of the impactor was greater than 1.0 mm. The width CL of the crack of the display device of the comparative example that fractured due to the impact of the impactor was greater than 2.0 mm. Accordingly, the display device 10 of the present example can reduce the step LD of the protector 200 and the width CL of the crack, and can reduce the lethality to the rider.

### Example 2

The display device 10 of Embodiment 2 was fabricated. The thickness T1 of the first glass substrate 210 was 0.33 mm or 0.50 mm. The pummel value of the first adhesive layer 230 was 7 or 9. The pummel value of the second adhesive layer 240 was the same as the pummel value of the first adhesive layer 230. The other configurations of the display device 10 of the present example were the same as those of the display device 10 of Example 1.

A display device of Comparative Example 2 was fabricated. The thickness T1 of the first glass substrate 210 in the display device of Comparative Example 2 was 0.50 mm. The pummel values of the first adhesive layer 230 and the second adhesive layer 240 was 5. With the exception of the thickness T1 of the first glass substrate 210 and the pummel values of the first adhesive layer 230 and the second adhesive layer 240, the configuration of the display device of Comparative Example 2 was the same as the display device 10 of the present example.

As in Example 1, the spherical impactor was caused to impact the center of the first main surface 210a of the first glass substrate 210 of the display device 10 of the present example or the display device of Comparative Example 2, and the average maximum diameter LA of the scattering material was obtained.

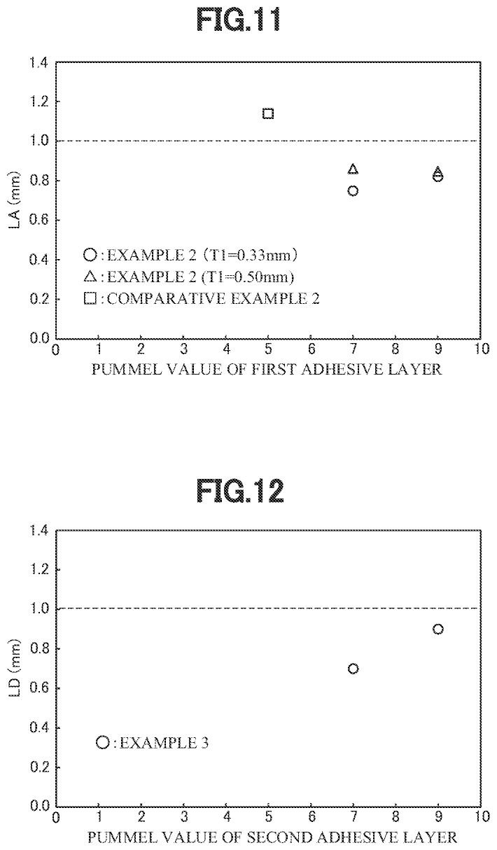

FIG. 11 illustrates the relationship between the pummel value of the first adhesive layer 230 and the average maximum diameter LA of the scattering material. As illustrated in FIG. 11, the average maximum diameter LA of the scattering material produced from the display device of the present example (pummel value of first adhesive layer 230: 7 or 9) was 1.0 mm or less and, thus, the size of the scattering material was small. Meanwhile, the average maximum diameter LA of the scattering material produced from the display device of Comparative Example 2 (pummel value of first adhesive layer 230: 5) was greater than 1.0 mm. Accordingly, by setting the pummel value of the first adhesive layer 230 to from 7 to 10, the size of the scattering material can be reduced and the lethality to the rider can be reduced.

### Example 3

The display device 10 of Embodiment 2 was fabricated. The thickness T1 of the first glass substrate 210 was 0.50 mm. The pummel value of the first adhesive layer 230 was 9. The pummel value of the second adhesive layer 240 was 9 or 7. The other configurations of the display device 10 of the present example were the same as those of the display device 10 of Example 1.

As in Example 1, the spherical impactor was caused to impact the center of the first main surface 210a of the first glass substrate 210 of the display device 10 of the present example, and the step LD was measured.

FIG. 12 illustrates the relationship between the pummel value of the second adhesive layer 240 and the step LD. As illustrated in FIG. 12, the step LD was 1.0 mm or less in the display device 10 in which the pummel value of the first adhesive layer 230 and the pummel value of the second adhesive layer 240 were set to 9, and in the display device 10 in which the pummel value of the first adhesive layer 230 was set to 9 and the pummel value of the second adhesive layer 240 was set to 7. Accordingly, by setting the pummel value of the second adhesive layer 240 to less than or equal to the pummel value of the first adhesive layer 230, the step LD can be reduced and the lethality to the rider can be reduced.

### Example 4

The display device 10 of Embodiment 2 was fabricated. In the display device 10 of the present example, the outer shapes of the first glass substrate 210, the second glass substrate 220, and the first adhesive layer 230 of the protector 200 were larger than the outer shape of the display 100. The thickness T1 of the first glass substrate 210 and the thickness T5 of the third glass substrate 250 were 0.50 mm. The thickness T2 of the second glass substrate 220 was 1.1 mm. That is, in the display device 10 of the present example, the thickness T2 of the second glass substrate 220 positioned between the first glass substrate 210 and the third glass substrate 250 was greater than the thickness T1 of the first glass substrate 210 and the thickness T5 of the third glass substrate 250. The other configurations of the display device 10 of the present example were the same as those of the display device 10 of Example 1.

The display device 10 of the present example was fixed to a jig 520 imitating an instrument panel of a vehicle. Under the conditions of the impact resistance test in the vehicle safety glass testing method of JIS regulation JIS R 3212:2015 (ISO regulation ISO 3528.1997), a steel sphere was caused to impact the center of the first main surface 210a of the first glass substrate 210 of the display device 10 fixed to the jig 520.

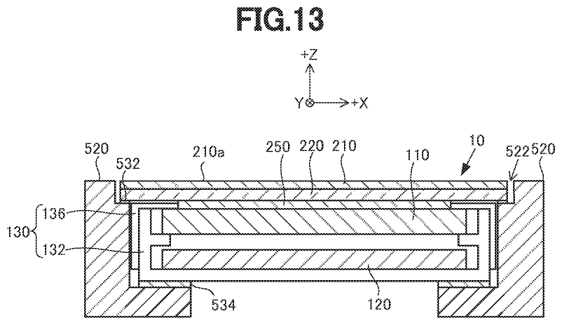

Specifically, as illustrated in FIG. 13, the display device 10 of the present example was fixed to an open section 522 of the jig 520. The second glass substrate 220 was adhered to a sidewall of the jig 520 by double-sided tape 532, and the bottom of the chassis 132 was adhered to a bottom plate, that has an opening, of the jig 520 by double-sided tape 534. In the present example, a steel sphere having a smooth surface, a mass of 227 g±2 g, and a diameter of about 38 mm was allowed to free-fall from a height of 9 m onto the center of the first main surface 210a of the first glass substrate 210. Note that the first adhesive layer 230, the second adhesive layer 240, and the like are omitted from FIG. 13.

As a result of causing the steel sphere to impact, the second glass substrate 220 fractured, but first glass substrate 210 and the third glass substrate 250 did not fracture. By setting the thickness T2 of the second glass substrate 220 positioned between the first glass substrate 210 and the third glass substrate 250 to greater than the thickness T1 of the first glass substrate 210 and the thickness T5 of the third glass substrate 250, it is thought that fracturing of the first glass substrate 210 and the third glass substrate 250 was suppressed due to the stress caused by the impactor concentrating in the second glass substrate 220 and the stress applied to the first glass substrate 210 and the third glass substrate 250 being mitigated. Since fracturing of the first glass substrate 210 positioned on the rider side and the third glass substrate 250 positioned on the display 100 side is suppressed, the display device 10 of the present example can suppress the scattering of pieces and can further reduce the lethality to the rider.

As described above, it is preferable that the thickness T2 of the second glass substrate 220 is greater than the thickness T1 of the first glass substrate 210 and the thickness T5 of the third glass substrate 250.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

1. A display device comprising:
a display panel; and
a protector provided on a display surface of the display panel, wherein
the protector includes a first glass substrate positioned on a user side, a second glass substrate positioned between the first glass substrate and the display surface, and a first adhesive layer that adheres the first glass substrate and the second glass substrate to each other,
a thickness of the first glass substrate is 0.5 mm or less, and
a pummel value of the first adhesive layer is from 7 to 10.

2. The display device according to claim 1, wherein the protector includes a second adhesive layer that adheres the second glass substrate and the display panel to each other.

3. The display device according to claim 2, wherein a pummel value of the second adhesive layer is less than or equal to the pummel value of the first adhesive layer.

4. The display device according to claim 3, wherein the protector is a touch panel that detects a contact position on the first glass substrate.

5. The display device according to claim 1, wherein the protector includes a third glass substrate positioned between the second glass substrate and the display surface, a second adhesive layer that adheres the second glass substrate and the third glass substrate to each other, and a third adhesive layer that adheres the third glass substrate and the display panel to each other.

6. The display device according to claim 5, wherein a pummel value of the second adhesive layer is less than or equal to the pummel value of the first adhesive layer.

7. The display device according to claim 6, wherein the protector is a touch panel that detects a contact position on the first glass substrate.

8. The display device according to claim 5, wherein a thickness of the second glass substrate is greater than a thickness of the first glass substrate and a thickness of the third glass substrate.

9. The display device according to claim 1, wherein the first glass substrate is formed from tempered glass.

10. The display device according to claim 2, wherein at least one of the first adhesive layer or the second adhesive layer is formed from polyvinyl butyral.
